(19) United States
(12) Patent Application Publication
(10) Pub. No.: US 2006/0118244 A1
(43) Pub. Date: Jun. 8, 2006

(54) Device for laying tape materials for aerospace applications

(75) Inventors: Kenneth P. Zaballos, Seattle, WA (US); Alan S. Locke, Seattle, WA (US); Brice A. Johnson, Federal Way, WA (US)

Correspondence Address: SHIMOKAJI & ASSOCIATES, P.C., 8911 RESEARCH DRIVE, IRVINE, CA, 92618, US

(73) Assignee: The Boeing Company, Chicago, IL (US)

(21) Appl. No.: 11/001,803

(22) Filed: Dec. 2, 2004

(51) Int. Cl. B32B 37/00

(52) U.S. Cl. 156/510; 83/13; 83/694

(57) ABSTRACT

A multiple head tape placement system includes several tape heads. Each tape head includes: a guide chute and a compaction roller for delivering a composite material to a mandrel. A backing is removed from the composite tape material before it reaches the compaction roller. Each tape head also includes a material cutter disposed to cut the composite tape material after the backing is removed and before the material reaches the compaction roller. The material cutter includes a curved blade with a convex cutting surface and a flat blade that contacts the curved blade in at most two contact points along a cutting edge of the flat blade as the flat blade moves vertically up and down past the curved blade with a horizontal rocking motion. The curved blade and the flat blade cut the composite tape material simultaneously in two opposing directions without laterally misaligning the composite tape material.

### CROSS REFERENCE TO RELATED APPLICATIONS

The present application is related to the following co-pending United States patent applications: U.S. application Ser. No. 10/851,381, filed May 20, 2004; U.S. application Ser. No. 10/822,538, filed Apr. 12, 2004; U.S. application Ser. No. 10/717,030, filed Nov. 18, 2003; U.S. application Ser. No. 10/646,509, filed Aug. 22, 2003; U.S. application Ser. No. 10/646,392, filed Aug. 22, 2003; U.S. application Ser. No. 10/646,316, filed Aug. 22, 2003; U.S. application Ser. No. 10/630,594, filed Jul. 28, 2003; and U.S. application Ser. No. 10/301,949, filed Nov. 22, 2002.

### BACKGROUND OF THE INVENTION

The present invention generally relates to manufacturing of large structures using composite materials and, more particularly, to laying composite laminate tape material for the manufacture of large aircraft fuselage sections.

The structural performance advantages of composites, such as carbon fiber epoxy and graphite bismaleimide (BMI) materials, are widely known in the aerospace industry. Aircraft designers have been attracted to composites, for example, because of their superior stiffness, strength, and lower weight. As more advanced materials and a wider variety of material forms have become available, aerospace usage of composites has increased. Composite materials have been applied using contour tape laminating machines (CTLM) and automated fiber placement machines (AFPM), for example, in the manufacture of parts such as wing panels and empennage. New and innovative composite lamination technologies are envisioned, such as the manufacture of large aircraft fuselage sections that may exceed, for example, 15 to 20 feet in diameter. For the manufacturing of comparatively smaller parts, such as wing panels and empennage, the CTLM and AFPM technologies have become highly developed, with large, massive, complex lay-up heads that perform well in the applications for which they have been developed. For the new applications of manufacturing large composite structures in the aerospace industry, however, composite lamination techniques that would provide, for example, faster material lay up rates could produce a break-though in productivity and reduce the cost of manufacturing.

Machines with multiple material delivery systems could significantly improve productivity. To take full advantage of multiple material delivery technology, e.g., machines with multiple delivery devices, and to make such technology economically and physically practical, however, requires the development of material lay-up heads that are smaller, lighter, less complicated, less expensive, and more reliable than the comparatively large and complicated lay-up heads of conventional CTLM and AFPM technologies that are used to manufacture comparatively smaller structures such as wing panels and empennage. Greater reliability is important, for example, because a tendency or statistical frequency of a material lay-up head to clog, jam, or misalign the material would be multiplied by the number of lay-up heads, potentially negating part or all of the benefit of multiple tape heads.

### SUMMARY OF THE INVENTION

A lightweight, simplified and relatively inexpensive material delivery device for the lay-up of large composite aircraft structures—such as fuselages—provides the ability to deploy multiple delivery systems within one machine. Such a material delivery system can lay up composite materials at high rates, yet can be replicated at low cost, given it's simplicity and small size, to enable multiple delivery systems on single machines capable of delivering material at rates (measured in pounds per hour, for example) that multiply current material delivery rates by orders of magnitude.

In one embodiment of the present invention, a material delivery system includes a cutting apparatus having a curved blade and a flat blade. The flat blade moves past the curved blade with a horizontal rocking motion so that the material is sheared at a moving contact point between the curved blade and the flat blade.

In another embodiment of the present invention, a tape head includes a material cutter disposed to cut the composite tape material after the backing is removed. The material cutter includes: a curved blade with a convex cutting surface and a flat blade that contacts the curved blade in at most two contact points along a cutting edge of the flat blade. The curved blade and the flat blade cut the composite tape material without moving the composite tape material sideways.

In still another embodiment of the present invention, a cutting apparatus includes a base; a carriage held to the base so that the carriage can slide vertically up and down with respect to the base; a curved blade having a convex front surface and attached to the base; and a flat blade having an inverted “V” shaped cutting edge and held to the carriage. A blade reaction spring is disposed between the flat blade and the carriage, and the blade reaction spring pushes against the flat blade so that the flat blade pivots and pushes at least one point of the cutting edge into contact with the curved blade.

In yet another embodiment of the present invention a multiple head tape placement system includes a plurality of tape heads. Each tape head includes features for delivering a composite material to a mandrel. A backing is removed from the composite tape material before it reaches a material cutter disposed to cut the composite tape material after the backing is removed and before the material reaches a compaction roller. The material cutter includes a curved blade with a convex cutting surface and a flat blade that contacts the curved blade in at most two contact points along a cutting edge of the flat blade The flat blade moves vertically up and down past the curved blade with a horizontal rocking motion. The curved blade and the flat blade cut the composite tape material simultaneously in two opposing directions without moving the composite tape material sideways.

In a further embodiment of the present invention, a tape lay-up machine includes at most one sliding guide point for a composite material. The sliding guide point is situated where backing material is removed from the composite material. A cutting apparatus is disposed to cut the composite material after the backing material is removed and before the composite material reaches a compaction roller. The cutting apparatus includes a base; a carriage held to the base by bearings; a curved blade having a convex front surface and fixedly attached to the base; and a flat blade having an inverted “V” shaped cutting edge and held to the carriage by a blade retainer. The blade retainer holds the flat blade so that the flat blade pivots horizontally against the blade retainer under the influence of a blade reaction spring and pushes at least one point of the cutting edge into contact with the curved blade. The flat blade contacts the curved blade in at most two contact points as the flat blade moves vertically past the curved blade with a horizontal rocking motion. The curved blade and the flat blade cut the composite tape material simultaneously in two opposing directions without moving the composite tape material sideways.

In a still further embodiment of the present invention, a method includes feeding a material past a curved blade; and moving a flat blade past the curved blade with a horizontal rocking motion so that the material is sheared at a moving contact point between the curved blade and the flat blade.

These and other features, aspects and advantages of the present invention will become better understood with reference to the following drawings, description and claims.

### BRIEF DESCRIPTION OF THE DRAWINGS

FIG. 1A is a perspective view of a multiple head lay-up machine in accordance with one embodiment of the present invention;

FIG. 1B is a perspective view of a multiple head lay-up machine in accordance with another embodiment of the present invention;

FIG. 2 is a side view diagram of a tape laying system in accordance with one embodiment of the present invention;

FIG. 3 is an isometric view of the tape laying system shown in FIG. 1;

FIG. 4 is an isometric view from a different angle of the tape laying system shown in FIG. 2;

FIG. 5 is a perspective view of a tape cutter in accordance with one embodiment of the present invention;

FIG. 6 is a front view of the tape cutter shown in FIG. 5;

FIG. 7 is a top view of the tape cutter shown in FIG. 6;

FIG. 8 is a bottom view of the tape cutter shown in FIG. 6;

FIG. 9 is a side view of the tape cutter shown in FIG. 6;

FIG. 10 is a side cross-sectional view of the tape cutter shown in FIG. 6 taken along line 10-10 in FIG. 6;

FIG. 11 is a second side cross-sectional view, similar to FIG. 10, of the tape cutter shown in FIG. 6 taken along line 11-11 in FIG. 7;

FIGS. 12A through 12E are front views of a tape cutter according to one embodiment of the present invention, showing the relative motion of the blades; and

FIG. 12F is a bottom view of a tape cutter according to one embodiment of the present invention, corresponding to the blade position shown in FIG. 12E.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The Boeing Company is exploring a variety of methods and tools for making large composite structures. The present application describes an invention that is one of a family of inventions for accomplishing this goal. The present application is related to the following co-pending United States patent applications that are part of this family: U.S. application Ser. No. 10/851,381, filed May 20, 2004, entitled “Composite Barrel Sections for Aircraft Fuselages and Other Structures, and Methods and Systems for Manufacturing such Barrel Sections”; U.S. application Ser. No. 10/822,538, filed Apr. 12, 2004, entitled “Systems and Methods for Using Light to Indicate Defect Locations on a Composite Structure”; U.S. application Ser. No. 10/717,030, filed Nov. 18, 2003, entitled “Method of Transferring Large Uncured Composite Laminates”; U.S. patent application Ser. No. 10/646,509, entitled “Multiple Head Automated Composite Laminating Machine For The Fabrication Of Large Barrel Section Components”, filed Aug. 22, 2003; U.S. patent application Ser. No. 10/646,392, entitled “Automated Composite Lay-Up To An Internal Fuselage Mandrel”, filed Aug. 22, 2003; U.S. patent application Ser. No. 10/646,316, entitled “Unidirectional, Multi-Head Fiber Placement”, filed Aug. 22, 2003; U.S. patent application Ser. No. 10/630,594, entitled “Composite Fuselage Machine”, filed Jul. 28, 2003; and U.S. patent application Ser. No. 10/301,949, entitled “Parallel Configuration Composite Material Fabricator”, filed Nov. 22, 2002; all of which are assigned to the assignee of the present invention and all of which are incorporated by reference into the present application.

Broadly, the present invention provides a lightweight, simplified and relatively inexpensive material delivery for the lay-up of large composite aircraft structures, such as fuselages. In one embodiment, a material delivery system (e.g., tape laying machine or “tape head”) is provided that can lay up composite materials at high rates, yet can be replicated at low cost, given it's simplicity and small size, thus enabling multiple delivery systems on single multiple tape head machines. The tape head of one embodiment is capable of delivering material at rates that exceed current material delivery rates and, combined with greater reliability and multiple head delivery, dramatically improves material delivery rates over current systems.

A material delivery device, e.g., tape head, according to one embodiment provides on-board the tape head composite material supply, material cutting and adding, nip-point heating, internal cooling, backing paper take-up, delivery tension management, and material compaction capability. The material delivery device is capable of delivering materials at higher rates than earlier technology.

In a novel material cutter, cutting contact between the blades is analogous to that of a high quality pair of scissors where the two scissor blades are arched and sprung against each other, being held together at the pivot, and contact each other at a single moving point (apart from the pivot) as the scissors are squeezed, shearing material at the moving contact point. Such a cutting action contrasts with flat blades having an overlapping area of sliding contact between the two blades that increases as the scissors are squeezed and often draws material into the flat overlapping area between the blades, sometimes jamming the blades or damaging the material without cutting it. The cutting action of the present cutter has less tendency to accumulate resins—such as epoxy—and other substances with which the tape material may be coated or pre-impregnated, possibly due to the minimized blade contact area. The reliability of the entire tape head may be improved.

The preferred cutter also can cut in opposing directions simultaneously, to reduce the tendency to slide the tape material sideways, possibly misaligning the pre-impregnated material (“pre-preg”) and requiring correction. Tape head down time is reduced.

The preferred device also carries all heaters, chillers, digital input/output (I/O), and pneumatic controls on the tape head itself and may also use a field-bus connected intelligent motor to reduce the number of tubes and wires that cross the boundary between the tape head and the rest of the lay-up machine and enabling a practical implementation of a “quick-changeable” tape head not seen in the prior art.

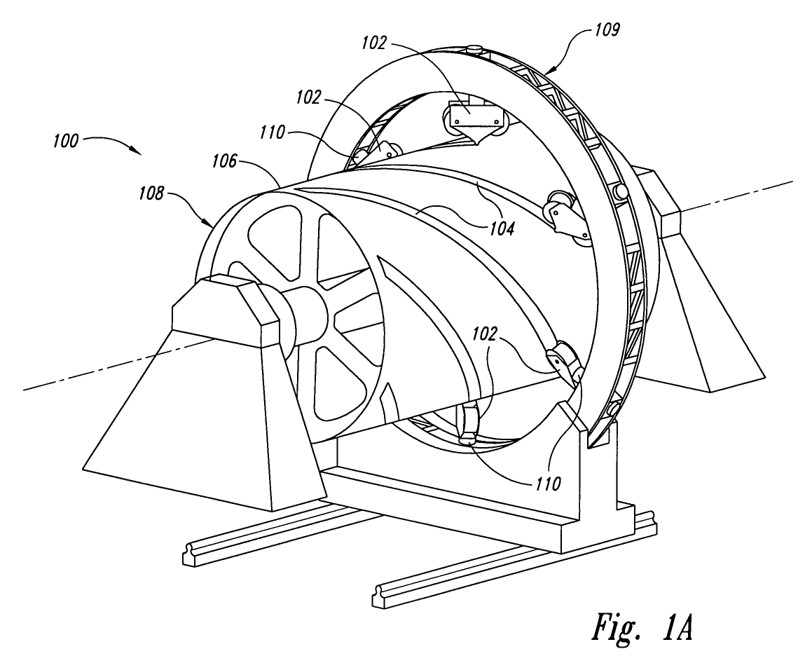

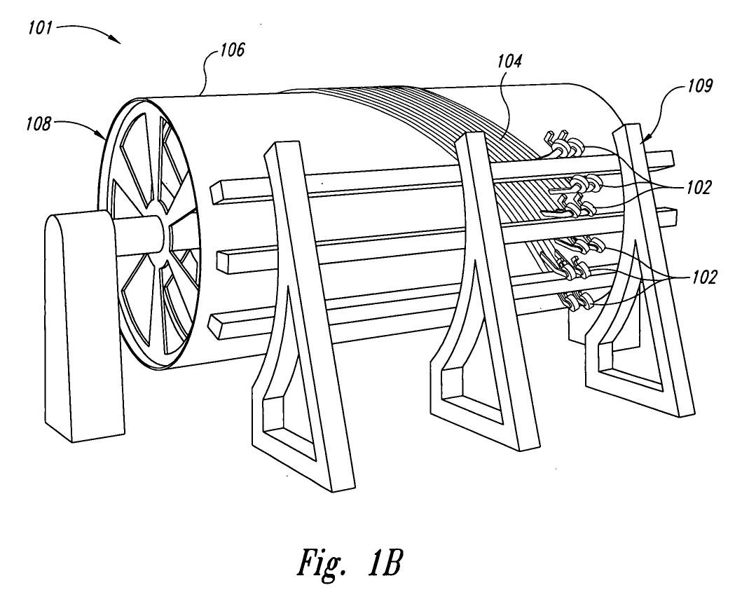

FIG. 1A illustrates a material delivery or tape laying system, which may include a multiple head tape lay-up machine 100. FIG. 1B illustrates another material delivery or tape laying system, which may include a multiple head tape lay-up machine 101. Lay-up machines 100 and 101 may include several tape heads 102 for placing “pre-preg” composite tape material 104 onto the surface 106 of a mandrel 108. Surface 106, for example, may be an inner mold line (IML) surface for a section of a large aircraft fuselage. Each tape head 102 may be attached to a carriage 109 associated with the mandrel 108 by a support mechanism 110, which may provide physical, mechanical support and various types of movement with respect to the carriage 109, and the tape heads 102 may simultaneously move independently of each other. Support mechanisms 110 may also carry connections to, for example, electrical power. Mechanism 110 may be considered as a “boundary” between tape head 102 and lay-up machine 100 or lay-up machine 101. To cover the surface 106 of mandrel 108 with tape 104, mandrel 108 may turn, or tape heads 102 may move relative to the mandrel 108, or any combination of movements may be used, including movements provided by mechanisms 110. Carriage 109 shown in FIG. 1A may be moved, for example, to carry all of tape heads 102 simultaneously axially along mandrel 108. Also, tape heads 102 may move, for example, axially along carriage 109 shown in FIG. 1B, simultaneously and independently of one another, as well as the carriage 109 itself being movable.

FIGS. 2, 3, and 4 show tape head 102 in greater detail. In the illustrated embodiment, composite tape materials 104 are supplied on a spool 112 and guided through a series of rollers 114 and a fixed guide chute 116 to maintain precise delivery. Backing paper 118 is removed prior to compaction and guided similarly to a take-up spool 120. Material 104 delivery tension is managed through active or passive torques, or both, placed on the supply spool 112, for example, by supply tensioning 113 and on take-up spool 120 by take-up tensioning 121. Cutting of the material 104 may occur between the point 122 where backing material is removed and point 124 where compaction occurs. Compaction forces are supplied through a precisely guided, compliant compaction actuator 126 connected to compaction roller 136. Heat 128, if desired, is applied to the target lay-down surface at a point on the tape path just ahead of the nip-point 130 to aid in tack down. This heat aids adhesion of the tape by slightly heating the surface to which it will be applied.

Composite tape material 104 may be supplied on reels wound on a cardboard core that can be mounted on supply spool 112. Material 104 may have backing paper 118 on the inside of the tape material 104 as it is wrapped around the core. When material 104 is paid out, any backing paper 118 is removed prior to reaching the cutting apparatus 138, also referred to more briefly as “material cutter”, and compaction roller 136. Typical tape widths range from 1.75 inch to 3.00 inch. Wider widths are practical, and the cutter according to one embodiment may cut any practical width of tape.

Removal of backing paper 118 before material 104 reaches material cutter 138 simplifies the requirements for cutting. There is no requirement to only cut through the material but not the backing paper. Cutting may be further simplified by the fact that only cuts perpendicular to the length of the tape 104 are required, so cutting apparatus 138 is positioned to cut perpendicular to material 104, e.g., perpendicular to the plane of the flat tape material 104 where it passes through cutting apparatus 138. Cutting apparatus 138 may be driven by an actuator 139, which can produce mechanical motion of a cutting blade of cutting apparatus 138. Cutting actuator 139, for example, may be a pneumatic actuator capable of applying approximately 85 pounds (lbs.) of force. The minimum force needed to cut the tape 104 is significantly less, however, and is approximately 30 pounds of force. A reduced cutting force results in a longer cutting time. Also, when epoxy resin builds up on the cutting surfaces, prolonged cutting is possible with greater force. The time for the cutter 138 to extend may be approximately 90 milliseconds (ms). The time is that required to trigger the sensor on the pneumatic actuator 139 that operates the cutter 138 mechanism. The amount of time that the blade of cutter 138 is actually cutting the material of tape 104 may be approximately half that or about 45 ms.

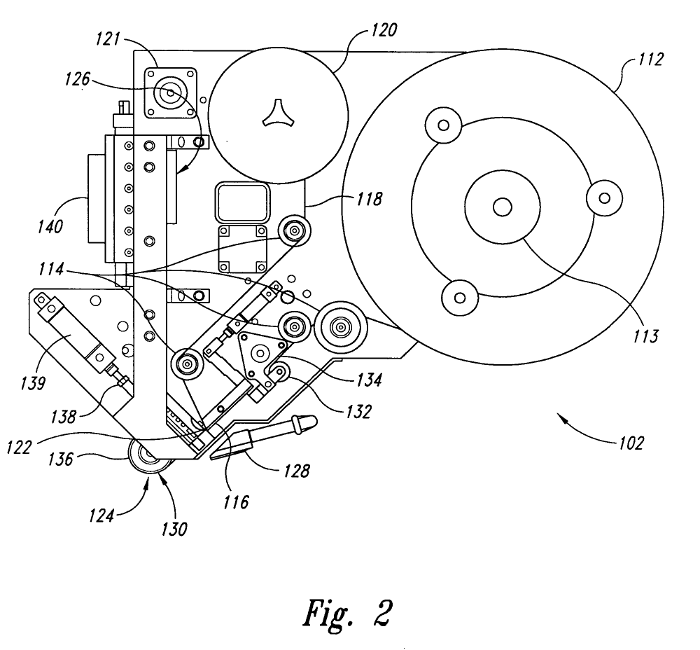

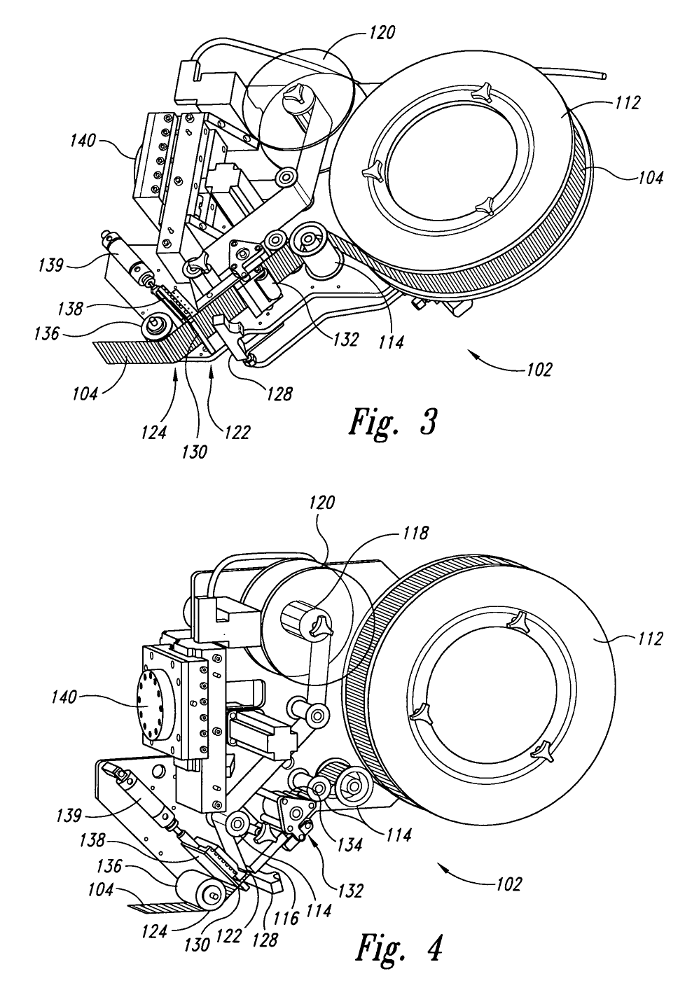

Composite tape material 104 may be a fibrous material with all fibers unidirectional. When pushed on the edges, material 104 may easily deform making guidance difficult. Resin may be stripped from the tape and build up on guide chute 116, and other surfaces where sliding of the material 104 occurs. As a result, the material 104 is conveyed with the backing paper 118 contacting the device's surfaces. In FIGS. 3 and 4, composite tape material 104 is shown as black and the backing paper 118 is shown as white. Chilled air may be delivered, for example, at the stationary guide chute 116 as well as cutting apparatus 138 to help prevent the composite matrix material 104, e.g. epoxy resins, from building up on sliding surfaces or cutter blades.

In addition to the material guidance features, e.g., guidance rollers 114 and fixed guide chute 116, of the tape head 102 that provide for accurate side-to-side placement of material 104, a “pinch” roller 132 engages a servo driven “add” roller 134 to precisely deliver material to the compaction roller 136 nip-point for placing material 104 while the product, e.g., surface 106, is moving or stationary and to accurately place material 104. When no material 104 is being placed, the add roller 134 may be stationary and the pinch roller 132 may be engaged. Both backing paper 118 and composite material 104 may be pinched against the add roller 134. This prevents motion of the tape material 104 thereby maintaining position registration relative to the nip-point 130. When material 104 is “added” the add roller 134 rotates, pulling material 104 and backing paper 118 off the supply spool 112 together. Once material 104 is under the compaction roller 136, the pinch roller 132 is released and the add roller 134 stops. Material 104 is pulled through the tape head 102 by the motion of the head 102 relative to the mandrel 108. Tension is maintained on the backing paper 118 so that, when material 104 is paid out, the backing paper 118 is taken up as required regardless of material 104 delivery rate.

The delivery device (e.g., tape head 102) can be adapted, for example, using coupling 140, to traditional machine tool-like machinery or to use as a robotic end-effecter, e.g., operational mechanism at the end of a robot arm. All heaters, e.g., heat 128, chillers, e.g., at guide chute 116, digital I/O and pneumatic controls, e.g., at coupling 140, reside on the tape head 102 itself to greatly reduce the number of tubes and wires that cross the boundary, e.g., support mechanism 110, between the tape head 102 and the rest of the machine 100 or 101. Such a design enables a practical implementation of a “quick-changeable” tape head 102, which can be more easily serviced, for example, by removing tape head 102 from machine 100 or 101. A “quick-changeable” tape head 102 reduces machine down time, for example, by replacing a malfunctioning tape head 102 with a stand-by unit.

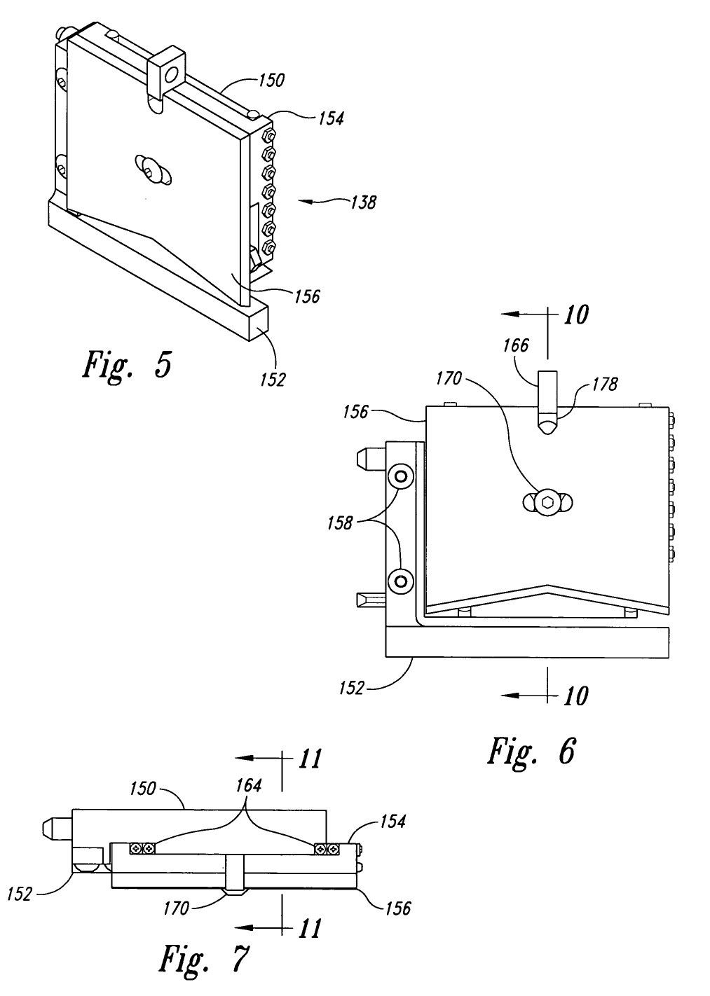

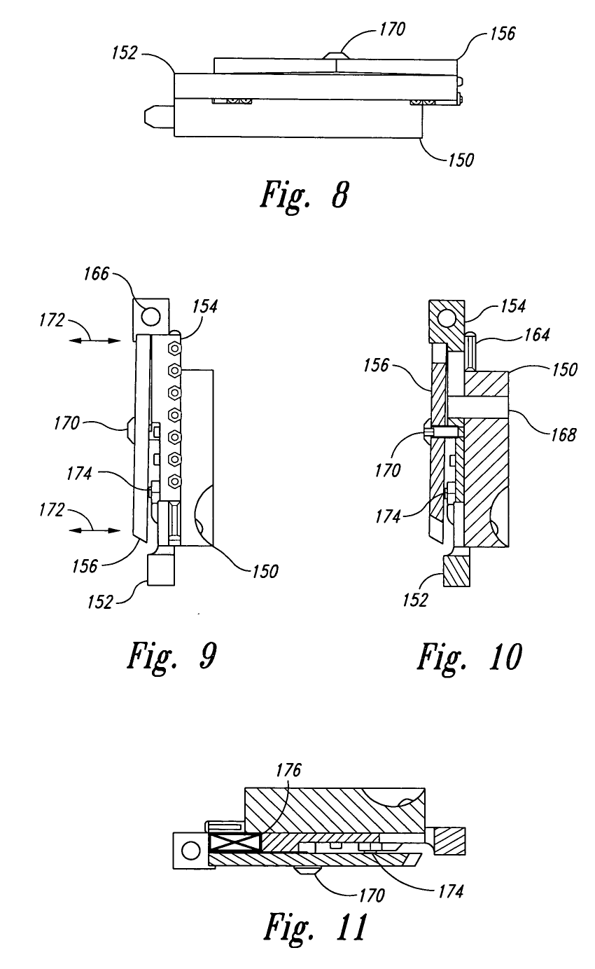

Referring now to FIGS. 5 through 11, cutting apparatus 138 is shown in greater detail. Cutting apparatus 138 may include a base 150 to provide mechanical support and attachment points for other components of cutter 138. Attached to tape head 102, the base 150 provides attachment of entire cutting apparatus 138 to tape head 102. Cutting apparatus 138 may also include a curved blade 152, carriage 154, and flat blade 156. Directions (e.g., up, down, forward, backward, sideways, vertical, horizontal, as well as sides, edges, or orientations of the components (e.g., top, bottom, front, back, side)) are described consistently and labeled in the figures where FIG. 6 is a front view, FIG. 7 a top view, FIG. 8 a bottom view, and FIG. 9 a side view.

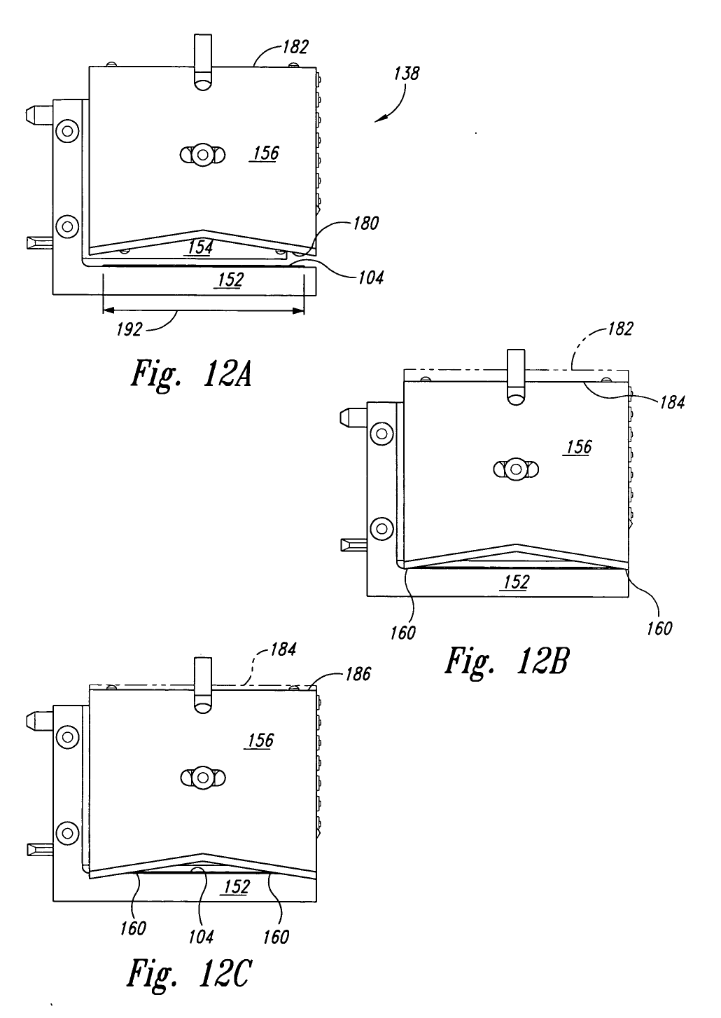

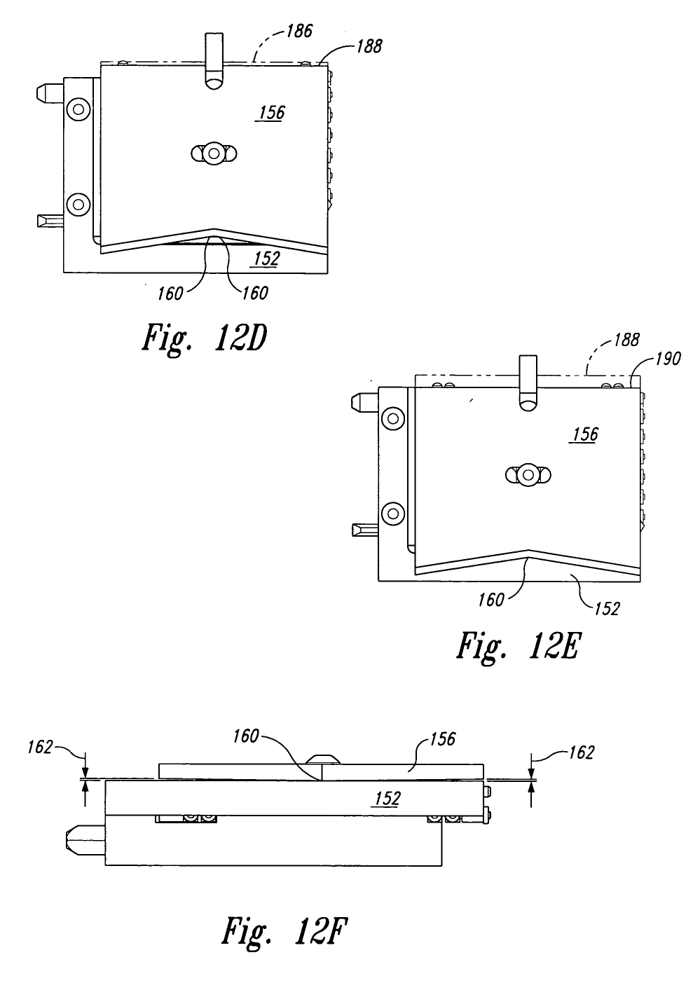

Curved blade 152 is fixed to base 150 using fasteners 158 (see FIG. 6), which may be bolts, for example. The front (cutting) surface of curved blade 152 may be a small segment of a circular cylinder having a longitudinal axis of symmetry that is vertical with respect to the labeling of views. Curvature of the blade surface can be seen more clearly in the bottom view of FIG. 12F, where with the flat blade 156 in the fully down position and cutting contact point 160 located at the center of the blades, gaps 162 occur at the side edges of the blades due to blade 152 being curved and blade 156 being flat with the flat surface of flat blade 156 being substantially parallel to a vertical, longitudinal axis of symmetry of the curved surface of blade 152 when flat blade 156 is in the fully down position. Gaps 162 may be approximately 0.015 inch, for example, in one embodiment. With flat blade 156 in the up position at the start of a cut—as shown FIG. 12B—the cutting contact points 160 are at the side edges of flat blade 156, and gaps 162 become closed. With flat blade 156 in the up position at the start of a cut, the top of flat blade 156 is rocked forward so that the flat surface of flat blade 156 may not be substantially parallel to a vertical axis of symmetry of the curved surface of blade 152. The shape of the front surface of curved blade 152 need not be restricted to a circular cross-section. For example, two straight ramps with a radius in the middle may work as well. In general, the front surface of curved blade 152 has a uniform cross-section that is convex as seen from the front when used with an inverted “V” flat blade 156, but may be concave when used with a non-inverted “V” flat blade 156. In addition, a chamfer-like relief immediately below the cutting edge on the curved front side of curved blade 152 reduces resin build-up on blades and increases the time between cleanings.

Carriage 154 is connected to base 150 by bearings 164 so that carriage 154 can slide vertically up and down. Movement may be supplied, for example, by an actuator 139 (FIGS. 2-4) attached to actuator connection point 166 (see, e.g., FIG. 9). A carriage travel stop pin 168 (FIG. 10) is affixed to base 150 and engages a slot in carriage 154 for limiting travel of carriage 154 and, consequently, of flat blade 156. The flat blade 156 normally is vertically fixed in relation to carriage 154.

Flat blade 156 is held on carriage 154 by blade retainer 170. If held loosely, flat blade 156 is free for a front-back rotation 172 (indicated by double arrows in FIG. 9) about a horizontal axis in the plane of the flat blade 156 that also passes through blade retainer 170. The front-back rotation 172, also referred to as horizontal rocking motion, may be stabilized and limited, for example, by shear side blade supports 174 and blade reaction springs 176. Flat blade 156 may be also be stabilized in a side-to-side direction, for example, by a slot 178 in flat blade 156 that may engage actuator connection point 166 attached to carriage 154. Shear side blade supports 174 are often attached to carriage 154 so that blade supports 174 contact the rear surface of flat blade 156 at one limit of rotation 172, e.g., with the top of flat blade 156 all the way forward. Blade reaction springs 176 may be disposed between carriage 154 and the rear (cutting) surface of flat blade 156 (FIG. 11) so that springs 176 push the top of flat blade 156 forward and provide a restorative force when the top of flat blade 156 has been rocked backward against springs 176 by blade moving forward when flat blade 156 descends.

FIGS. 12A through 12F illustrate blade motion and cutting action in accordance with a preferred embodiment. The shearing motion illustrated in FIGS. 12A through 12E is defined as the action of the two blades 152, 156 while moving past each other with a rocking motion, to avoid sideways movement of the tape on convex cutting surface, the front surface of blade 152. FIGS. 12A through 12E are front views, and FIG. 12F is a bottom view, that are consistent in direction and orientation with the views of FIGS. 6 through 11 so that descriptions of direction and orientation are described consistently.

Flat blade 156 has a cutting edge 180 (FIG. 12A) with an inverted “V” shape. Inverted “V” shape cutting edge 180 provides a cutting action that cuts in two opposing directions simultaneously. Such a cutting action may produce a zero net sideways force on material to be cut, e.g., tape material 104, helping to prevent misalignments of the material due to cutting operations. A single action cutting blade could achieve a cutting action in one direction only. For example, a cutting edge 180 could be provided that is straight all the way across, at an angle to horizontal similar to either leg of the inverted “V” shape cutting edge, and with appropriate adjustment to the curvature of curved blade 152, and such a blade could be advantageous for applications where the balanced cutting of an inverted “V” shape cutting edge may not be required.

As shown in FIG. 12A, the flat blade 156 is initially held clear of the material 104 to be cut, e.g., at initial position 182. The flat blade 156 is supported on three points, two points on the shearing side, e.g., shear side blade supports 174, and one on the front side, e.g., blade retainer 170 (see FIGS. 5 through 11). These supports are common to the carriage 154 and travel with the flat blade 156 while it moves through the cutting motion. Two springs, e.g., blade reaction springs 176, force the flat blade 156 against these supports 170, 174 so that precise initial contact 160 (see FIG. 12B) may be made with the curved blade 152.

As shown in FIG. 12B, when the cutting process is started, the flat blade 156 descends (e.g., from initial position 182 to position 184) and contacts 160 (at one point or two points, depending on the shape of cutting edge 180) with the outer curved surface, e.g., front surface, of the curved blade 152. Support of the flat blade 156 may be transferred from the shear side blade supports 174 to the contact points 160.

As shown in FIG. 12C, the two points of contact 160 between the flat blade 156 and the curved blade 152 move symmetrically inward as the flat blade 156 descends (e.g., from position 184 to position 186). The symmetric movement of contacts 160 maintains the lateral position of the material 104 throughout the cutting process. Because the curved blade 152 is curved and convex toward the front, the flat blade 156 rocks back at the top, pivoting against the blade retainer 170 and pushing against blade reaction springs 176. The material 104 is sheared in a manner similar to the mechanics of a high quality pair of scissors so that, as the flat blade 156 descends (e.g., from position 186 to position 188 as seen in FIG. 12D), the amount of material 104 being sheared at any contact point 160 is essentially constant through the cutting process. The width 192 of material 104 is irrelevant to the force required to perform the cut. Thus, cutter 138 differs from prior art guillotine mechanisms that require a force that is linearly coupled to the width 192 of the material 104.

As shown in FIG. 12E, the final cleaving of the material occurs at the center of the flat blade 156 as contact points 160 come together at a single contact 160 as flat blade 156 descends (e.g., from position 188 to position 190). FIG. 12F shows a bottom view with flat blade 156 at the final down position with a single contact point 160 at the middle of the blades 152, 156.

The description relates to exemplary embodiments of the invention. Modifications may be made without departing from the spirit and scope of the invention as set forth in the following claims.

We claim:

1. A tape laying system for placing composite pre-preg on a mandrel, comprising:
a cutting apparatus having a curved blade opposed with a flat blade, wherein:
a horizontal rocking motion shears at a moving contact point between the blades.

2. The tape laying system of claim 1 wherein:
the flat blade has a top and a front;
the flat blade moves downward past the curved blade during the shearing; and
the flat blade rocks backward at the top while moving downward so that contact between the blades occurs over at most two points, and not over a sliding contact area.

3. The tape laying system of claim 1 wherein:
contact between the blades occurs only at a cutting edge of the flat blade.

4. The tape laying system of claim 1 wherein:
contact between the blades occurs at two moving contact points; and
the moving contact points move symmetrically during the shearing.

5. The tape laying system of claim 4, wherein:
the material is sheared in opposing directions simultaneously beginning at each contact point.

6. The tape laying system of claim 1, further including a blade retainer and a blade reaction spring wherein:
the curved blade pushes the flat blade at the moving contact point to pivot the flat blade at the blade retainer and to push the flat blade against the blade reaction spring.

7. The tape laying system of claim 1, wherein:
the flat blade is mounted on a carriage by a blade retainer; and
the carriage moves the flat blade past the curved blade.

8. The tape laying system of claim 7, further including:
a blade reaction spring disposed between the carriage and the flat blade; and
the curved blade pushes the flat blade at the moving contact point to pivot the flat blade at the blade retainer and to push the flat blade against the blade reaction spring.

9. The tape laying system of claim 1, wherein the curved blade has a front surface that is convex.

10. The tape laying system of claim 1, wherein the flat blade has a cutting edge with an inverted “V” shape.

11. The tape laying system of claim 1, wherein material is sheared without the blades imposing significant net sideways forces on the material.

12. The tape laying system of claim 1, wherein material remains aligned between the blades when cut.

13. A tape head comprising:
a material cutter disposed to cut the composite tape material, including:
a curved blade with a convex cutting surface; and
a flat blade that contacts the curved blade in at most two contact points along a cutting edge of the flat blade during shearing action so that:
the blades cut the material without moving the material sideways.

14. The tape head of claim 13, wherein the flat blade has a “V” shaped cutting edge and, with the curved blade, cuts the material symmetrically in two opposing directions simultaneously.

15. The tape head of claim 13, wherein one blade rocks horizontally as the rocking blade moves vertically past the other blade.

16. The tape head of claim 13, wherein:
one blade undergoes a rocking motion and moves past the other blade in a tape shearing motion; and
the rocking motion results from the other blade pushing the rocking blade from at least one of the contact points against a blade reaction spring.

17. A cutting apparatus comprising:
a base;
a carriage held to the base so that the carriage can slide with respect to the base;
a first blade having a convex front surface, the first blade being attached to the base;
a second blade, having an inverted “V” shaped cutting edge, mounted on the carriage; and
a blade reaction spring disposed between the second blade and the carriage, wherein the blade reaction spring pushes against the second blade so that the second blade pivots with respect to the carriage and pushes at least one point of the cutting edge into contact with the first blade during a shearing motion when the carriage slides with respect to the base.

18. The cutting apparatus of claim 17 wherein:
the blade reaction spring pushes against the second blade so that two points contact between the cutting edge and the first blade at the beginning of a cut;
the two points of contact move symmetrically when the second blade moves past the first blade in the shearing motion; and
the material is cut simultaneously in opposing directions beginning at the two points of contact.

19. The cutting apparatus of claim 17, further comprising a shear side blade support attached to the carriage wherein the blade reaction spring pushes the second blade into contact with the shear side blade support before beginning a cut.

20. The cutting apparatus of claim 17, further comprising a blade retainer attached to the carriage wherein the blade retainer holds the second blade fixed in one plane with respect to the carriage while the second blade pivots in an orthogonal plane against the blade retainer.

21. A tape placement system comprising:
at least one tape head, wherein each tape head comprises:
a guide chute and a compaction roller for delivering a composite tape to a mandrel;
a material cutter disposed to cut the tape before the tape reaches the compaction roller, wherein the cutter includes:
a first blade with a convex cutting surface; and
a second blade that contacts the first blade in at most two contact points along a cutting edge of the second blade during a shearing motion that includes a rocking motion for the second blade, and wherein:
the blades cut the tape simultaneously in two opposing directions without moving the material sideways along the cutting surface.

22. The system of claim 21, wherein each tape head carries a coupling to reduce digital input/output and pneumatic control connections across a boundary between each tape head and a tape dispensing system associated with the head.

23. A tape placement machine, comprising:
at most one sliding guide point for composite tape, the sliding guide point at a backing removal point where a backing material is separated from the tape;
a compaction roller for delivering the tape to a mandrel after the backing material is separated;
a cutting apparatus disposed to cut the tape after the backing material is separated and before the compaction roller; the cutting apparatus comprising:
a base;
a carriage held to the base by bearings so that the carriage can slide in a first plane with respect to the base;
a first blade, having a convex front surface, attached to the base;
a second blade, having an inverted “V” shaped cutting edge, held on the carriage by a blade retainer wherein the blade retainer holds the second blade fixed in the first plane with respect to the carriage while allowing the second blade to pivot in a second plane orthogonal to the first plane; and
a blade reaction spring disposed between the second blade and the carriage to push the cutting edge into contact with the first blade and wherein:
the second blade contacts the first blade in at most two contact points along the cutting edge during a shearing motion, and
the blades cut the tape simultaneously in two opposing directions without moving the tape sideways on the cutting surface.

24. A method of shearing tape, comprising the steps of:
feeding tape past a first blade having a convex cutting surface; and
shearing the tape at at least one moving contact point between the first blade and a second blade.

25. The method of claim 24, wherein there are two moving contact points between the blades during the shearing.

26. The method of claim 25, wherein:
the two moving contact points move symmetrically.

27. The method of claim 24, wherein:
shearing cuts the tape at two moving contact points in two opposing directions simultaneously.

28. The method of claim 24, wherein one blade rocks relative to the other blade during the shearing.

29. The method of claim 28, wherein:
rocking occurs by one blade pushing the other blade from a contact point against a blade retainer and a blade reaction spring disposed between a carriage and that blade.

30. A tape placement system, comprising:
a mandrel for receiving tape;
a carriage associated with the mandrel for holding at least one tape head for laying tape on the mandrel;
a tape head carried on the carriage associated with the mandrel;
a tape cutter on the head for cutting the tape with a shearing motion.

31. The tape placement system of claim 30, further comprising:
at most one sliding guide point for composite tape, the sliding guide point at a backing removal point where a backing material is separated from the tape;
a compaction roller for delivering the tape to the mandrel after the backing material is separated; and wherein:
the tape cutter is disposed to cut the tape after the backing material is separated and before the compaction roller.

32. The tape placement system of claim 30, further comprising:
a plurality of tape heads carried on the carriage, and moving simultaneously independently with respect to the carriage, each of the tape heads having a tape cutter on the head for cutting tape with a shearing motion.

33. The tape placement system of claim 30, wherein each tape head carries a coupling to reduce digital input/output and pneumatic control connections across a boundary between each tape head and the carriage.

34. The tape placement system of claim 30, wherein the mandrel turns to cover the surface of the mandrel with tape.

35. The tape placement system of claim 30, wherein the carriage moves to cover the surface of the mandrel with tape.

36. The tape placement system of claim 30, wherein the mandrel turns and the carriage moves to cover the surface of the mandrel with tape.

37. The tape placement system of claim 32, wherein the tape heads move along the carriage to cover the surface of the mandrel with tape.

38. The tape placement system of claim 37, wherein the mandrel turns independently of tape head movement to cover the surface of the mandrel with tape.

39. The tape placement system of claim 30, wherein the surface of the mandrel corresponds to an inner mold line surface of an airplane fuselage section.
